(19) United States
(12) Patent Application Publication
(10) Pub. No.: US 2026/0358640 A1
(43) Pub. Date: Nov. 12, 2026

(54) DIOPTER ADJUSTMENT DEVICE

(71) Applicant: AAC ACOUSTIC TECHNOLOGIES (SHENZHEN) CO., LTD., Shenzhen (CN)

(72) Inventors: Songtao Li, Shenzhen (CN); Qingshan Xu, Shenzhen (CN); Hongyan Tao, Shenzhen (CN)

(21) Appl. No.: 19/319,782

(22) Filed: Sep. 5, 2025

Related U.S. Application Data
(63) Continuation of application No. PCT/CN2025/094327, filed on May 12, 2025.

(51) Int. Cl. G02B 27/01

(52) U.S. Cl. CPC G02B 27/0176; G02B 27/0172

(57) ABSTRACT

Disclosed is a diopter adjustment device. The diopter adjustment device includes a frame secured to a lens module, and a screen movement module. The screen movement module includes a cover plate, a drive assembly, a guide assembly, and a display screen assembly, where the cover plate is secured to the frame, the drive assembly is disposed on the cover plate, and the drive assembly is provided with an output member extending along a first direction. The guide assembly includes at least three guide shafts secured to the cover plate and extending along the first direction, with the at least three guide shafts arranged to surround the output member. The display screen assembly is drivingly connected to the output member and slidably connected to the guide shafts.

### TECHNICAL FIELD

The present disclosure relates to the technical field of lens, and in particular, relates to a diopter adjustment device.

### BACKGROUND

With the ongoing development of augmented reality (AR) technology, AR glasses are gaining widespread attention as an important display device. To meet the different visual needs of users, AR glasses typically include a diopter adjustment device. The diopter adjustment device adjusts the position of the optical elements within the AR glasses to provide a sharp and clear image. However, the assembly process for existing diopter adjustment devices is often complex, requiring precise alignment of a plurality of parts. This not only increases manufacturing costs but also reduces production efficiency. Additionally, the display screen in AR glasses is connected to a flexible printed circuit (FPC). Under the elastic force of the FPC, the display screen is prone to skewing. Once the display screen is skewed, the propagation path of light is altered, which affects image clarity and accuracy, resulting in a poorer visual experience.

Therefore, it is necessary to provide a diopter adjustment device that is easier to assemble and improve the visual experience of the user.

### SUMMARY

The present disclosure is intended to provide a diopter adjustment device to solve the problems of difficult assembly and display screen skew found in the related art.

The present disclosure employs the following technical solution:

Embodiments of the present disclosure provide a diopter adjustment device. The diopter adjustment device includes a frame secured to a lens module and a screen movement module. The screen movement module includes a cover plate, a drive assembly, a guide assembly, and a display screen assembly. The cover plate is secured to the frame, and the drive assembly is disposed on the cover plate. The drive assembly has an output member extending along a first direction. The guide assembly includes at least three guide shafts, which are secured to the cover plate, extend along the first direction, and are arranged to surround the output member. The display screen assembly is drivingly connected to the output member and slidably connected to the guide shafts, such that the display screen assembly is capable of moving relative to the lens module along the first direction under the drive of the drive assembly to adjust a diopter.

In some embodiments, the display screen assembly includes a screen bracket and a display screen. The screen bracket is drivingly connected to the output member and slidably connected to the guide shafts, with a retaining slot defined in one end of the screen bracket in the first direction. The display screen is secured to the screen bracket and at least partially received within the retaining slot.

In some embodiments, the at least three guide shafts include at least two first guide shafts and at least one second guide shaft. The screen bracket includes a first frame body, a second frame body, and a securing member. The retaining slot is defined in the first frame body. At least two first guide holes are defined in the first frame body, and the at least two first guide holes are slidably connected to the corresponding at least two first guide shafts. The second frame body is disposed on a side of the first frame body in a second direction, which is perpendicular to the first direction. At least one second guide hole is defined in the second frame body, and the at least one second guide hole is slidably connected to the corresponding at least one second guide shaft. The securing member is configured to secure the first frame body and the second frame body. The first frame body and the second frame body jointly define an assembly hole that is drivingly connected to the output member.

In some embodiments, the securing member includes a threaded portion and a spring portion. The threaded portion passes through the second frame body along the second direction and is threadedly connected to the first frame body. The spring portion is sleeved on the threaded portion and compressed between the threaded portion and the second frame body along the second direction, such that a surface of each of the at least two first guide shafts is brought into contact with a hole wall of a respective one of the at least two first guide holes, and a surface of the at least one second guide shaft is brought into contact with a hole wall of the at least one second guide hole.

In some embodiments, the drive assembly further includes a motor secured to the cover plate. An output shaft of the motor is a worm, and the worm extends along a third direction perpendicular to the first direction. The output member includes a worm gear portion and a lead screw portion. The lead screw portion is defined at one end of the worm gear portion in the first direction. The worm gear portion is drivingly connected to the worm, and the lead screw portion is drivingly connected to the display screen assembly.

In some embodiments, the screen movement module further includes a magnet and a magnetic sensor. The magnet is secured to one end of the output member and arranged coaxially with the output member. The magnetic sensor is secured to the cover plate and configured to detect a rotation angle of the magnet.

In some embodiments, the frame and the cover plate enclose to form an accommodating space, and the display screen assembly is received within the accommodating space.

In some embodiments, the cover plate is secured to the frame by adhesive bonding.

In some embodiments, the at least three guide shafts are interference-fitted to the cover plate.

In some embodiments, the screen movement module further includes a limiting frame. The limiting frame includes a plate body and connecting posts. The plate body is spaced apart from the cover plate in the first direction. One end of each of the connecting posts in the first direction is secured to the plate body, and another end of each of the connecting posts in the first direction is secured to the cover plate. One end of each of the at least three guide shafts in the first direction is secured to the cover plate, and another end of each of the at least three guide shafts in the first direction is secured to the plate body.

The beneficial effects of the embodiments of the present disclosure are as follows: The diopter adjustment device adopts a modular design. The assembled lens module is secured to the frame as an integral module. Meanwhile, the drive assembly, the guide assembly, and the display screen assembly are assembled onto the cover plate to form another integral module, namely the screen movement module, which is then secured to the frame. By dividing the diopter adjustment device into multiple modules, the assembly process is simplified. This effectively addresses the problem of a complicated assembly processes due to the need to mount each part onto the frame one by one, thus improving assembly efficiency and assembly precision. Moreover, the present disclosure employs at least three guide shafts arranged around the output member. This configuration provides more stable guidance and limiting for the display screen assembly, and effectively prevents the display screen assembly from skewing during use, improving the accuracy and clarity of imaging, and enhancing the visual experience of the user.

### BRIEF DESCRIPTION OF THE DRAWINGS

FIG. 1 is a schematic three-dimensional structural view of a diopter adjustment device according to some embodiments of the present disclosure;

FIG. 2 is a schematic exploded view of the diopter adjustment device as illustrated in FIG. 1;

FIG. 3 is a schematic structural view of a screen movement module in the diopter adjustment device according to some embodiments of the present disclosure;

FIG. 4 is a schematic structural view of the screen movement module, with a limiting frame removed, in the diopter adjustment device according to some embodiments of the present disclosure;

FIG. 5 is a schematic structural view of a screen movement module in the diopter adjustment device according to some embodiments of the present disclosure;

FIG. 6 is a schematic structural view of the screen movement module, with a magnetic sensor and a third printed circuit board removed, in the diopter adjustment device according to some embodiments of the present disclosure;

FIG. 7 is a schematic structural view of a screen movement module in the diopter adjustment device according to some embodiments of the present disclosure;

FIG. 8 is an A-A sectional view of FIG. 7;

FIG. 9 is a B-B sectional view of FIG. 7;

FIG. 10 is a schematic exploded view of the screen movement module in the diopter adjustment device according to some embodiments of the present disclosure; and

FIG. 11 is a schematic structural view of a screen bracket in the diopter adjustment device according to some embodiments of the present disclosure.

### DETAILED DESCRIPTION OF THE EMBODIMENTS

The present disclosure is further described with reference to and the attached drawings and specific embodiments.

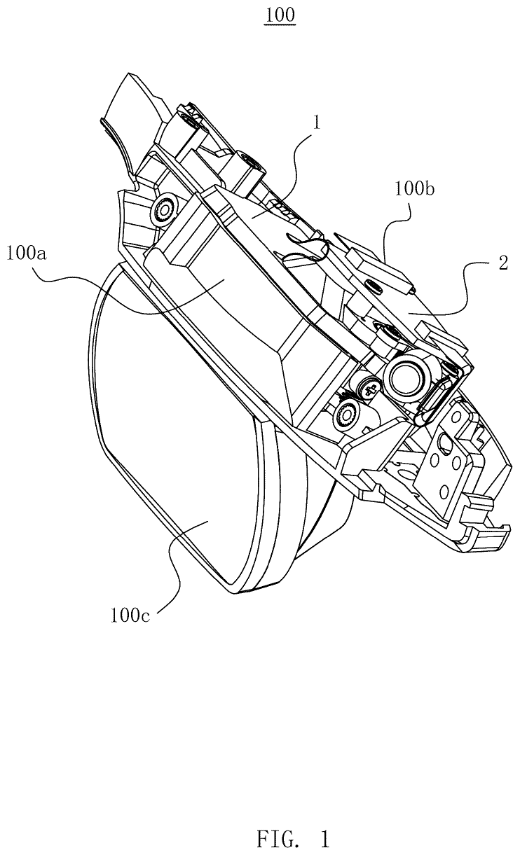

Referring to FIGS. 1 to 10, some embodiments of the present disclosure provide a diopter adjustment device 100. The diopter adjustment device 100 includes a frame 100a and a screen movement module 100b. The frame 100a is secured to a lens module 100c. The screen movement module 100b includes a cover plate 1, a drive assembly 2, a guide assembly 3, and a display screen assembly 4. The cover plate 1 is secured to the frame 100a, and the drive assembly 2 is disposed on the cover plate 1. The drive assembly 2 includes an output member 21 extending along a first direction. The guide assembly 3 includes at least three guide shafts 31, which are secured to the cover plate 1. All the guide shafts 31 extend along the first direction and are arranged to surround the output member 21. The display screen assembly 4 is drivingly connected to the output member 21 and is slidably connected to the guide shafts 31. the display screen assembly 4 is capable of moving relative to the lens module 100c along the first direction under the drive of the drive assembly 2 to adjust a distance between the display screen assembly 4 and the lens module 100c, such that the diopter is adjusted.

The diopter adjustment device 100 according to the embodiments of the present disclosure adopts a modular design. The assembled lens module 100c is secured to the frame 100a as an integral module. Simultaneously, the drive assembly 2, the guide assembly 3, and the display screen assembly 4, after being assembled to the cover plate 1, form another integral module, namely the screen movement module 100b, which is secured to the frame 100a. By dividing the diopter adjustment device 100 into multiple modules, the embodiments of the present disclosure simplify the assembly process. This effectively addresses the problem of a complicated assembly process due to the need to mount each part onto the frame 100a one by one, thus improving assembly efficiency and assembly precision. Moreover, the embodiments of the present disclosure employ at least three guide shafts 31 arranged around the output member 21. This configuration provides more stable guidance and limiting for the display screen assembly 4, and effectively prevents the display screen assembly 4 from skewing during use, improving the accuracy and clarity of imaging, and enhancing the visual experience of the user.

In some embodiments, the guide shafts 31 are interference-fitted to the cover plate 1. This configuration is not only structurally stable but also facilitates assembly, thereby reducing assembly costs.

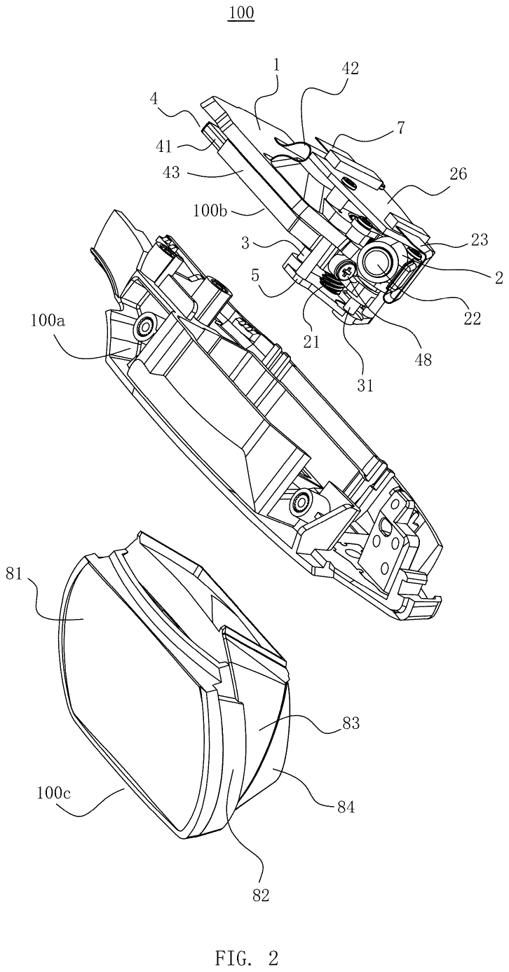

In some embodiments, referring to FIGS. 2 to 4 and FIGS. 7 to 10, the screen movement module 100b further includes a limiting frame 5. The display screen assembly 4 is constrained between the limiting frame 5 and the cover plate 1 along the first direction. The limiting frame 5 includes a plate body 51 and a plurality of connecting posts 52. Exemplarily, the connecting posts 52 and the plate body 51 are integrally formed. The plate body 51 is disposed spaced apart from the cover plate 1 in the first direction. One end of each of the connecting posts 52 in the first direction is connected to the plate body 51, and the other end of each of the connecting posts 52 in the first direction is secured to the cover plate 1. One end of each of the guide shafts 31 in the first direction is secured to the cover plate 1, and the other end of each of the guide shafts 31 in the first direction is secured to the plate body 51.

In the embodiments, by providing the plurality of connecting posts 52 between the plate body 51 and the cover plate 1, not only is the distance between the plate body 51 and the cover plate 1 effectively constrained, but the connection between the plate body 51 and the cover plate 1 is also made more stable. The plate body 51 and the cover plate 1 cooperate to confine the range of movement of the display screen assembly 4 to the space between the plate body 51 and the cover plate 1. This not only effectively limits the movement range of the display screen assembly 4, but also effectively protects the display screen assembly 4.

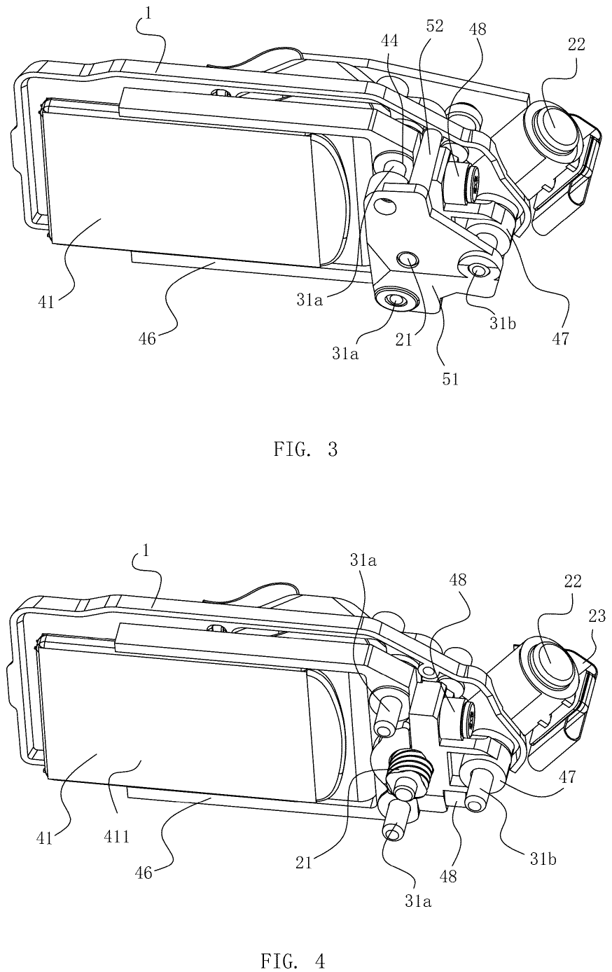

In some more preferred embodiments, referring to FIGS. 3, 8, and 10, the limiting frame 5 includes three connecting posts 52, wherein the three connecting posts 52 are arranged to surround the output member 21.

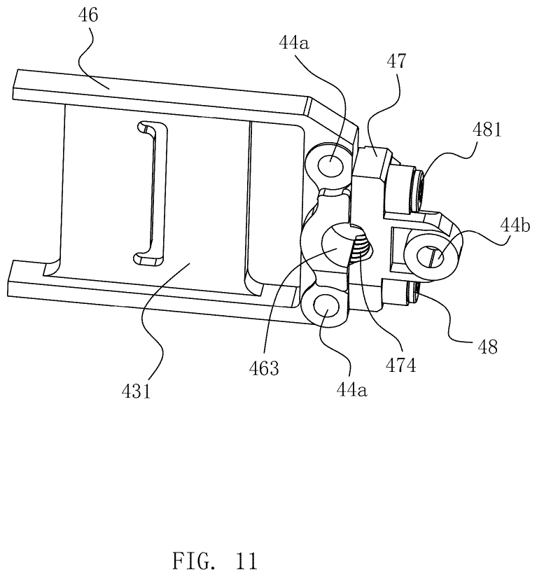

In some embodiments, referring to FIGS. 2 to 4 and FIGS. 8 to 11, the display screen assembly 4 includes a display screen 41 and a screen bracket 43. The screen bracket 43 is drivingly connected to the output member 21 and slidably connected to the guide shafts 31. The display screen 41 is secured to a side of the screen bracket 43 in the first direction. A receiving slot 431 is defined in one end of the screen bracket 43 in the first direction, and at least a portion of the display screen 41 is received in the receiving slot 431. A screen surface 411 of the display screen 41 faces away from the receiving slot 431 in the first direction. The screen bracket 43 is formed with at least three guide holes 44, each of which 4 is slidably connected to a corresponding one of the guide shafts 31. The screen bracket 43 is further formed with an assembly hole 45, which is drivingly connected to the output member 21. Exemplarily, a female threaded structure configured to engage with the output member 21 is formed on an inner wall of the assembly hole 45.

In the embodiments, the screen bracket 43 may effectively support the display screen 41, thereby improving the strength of the display screen assembly 4. With at least a portion of the display screen 41 accommodated within the receiving slot 431, not only is a tighter connection between the display screen 41 and the screen bracket 43 achieved, which reduces the volume of the display screen assembly 4, saves space, and provides a more stable structure, but also the possibility of loosening of the display screen 41 due to external impact or vibration is also reduced. Furthermore, during assembly, preliminary securing may be achieved by simply aligning and inserting the display screen 41 into the receiving slot 431. The connection between the display screen 41 and the screen bracket 43 may be further reinforced by other auxiliary fixing means such as adhesive or screws. The embodiments facilitate disassembly, allowing maintenance personnel to easily remove the display screen 41 from the receiving slot 431 for repair or replacement, thereby improving maintenance efficiency. Moreover, since the screen surface 411 of the display screen 41 faces away from the receiving slot 431 in the first direction, the screen bracket 43 does not obstruct the screen surface 411. That is, no interference is caused to imaging of the diopter adjustment device 100.

In some more embodiments, referring to FIGS. 4, 8, and 10, the guide shafts 31 include at least two first guide shafts 31a and at least one second guide shaft 31b. The screen bracket 43 includes a first frame body 46, a second frame body 47, and a securing member 48. The first frame body 46 is secured to the display screen 41, and at least two first guide holes 44a are defined in the first frame body 46. Each of the first guide holes 44a is slidably connected to a corresponding one of the first guide shafts 31a. The second frame body 47 is disposed on a side of the first frame body 46 in a second direction, the second direction being perpendicular to the first direction. At least one second guide hole 44b is defined in the second frame body 47, each of the at least one second guide hole 44b being slidably connected to a corresponding one of the second guide shafts 31b. The securing member 48 is configured to secure the first frame body 46 and the second frame body 47. The first frame body 46 and the second frame body 47 jointly define the assembly hole 45.

In the embodiments, the screen bracket 43 includes two frame bodies, namely the first frame body 46 and the second frame body 47, and the guide holes 44 are distributed across the two frame bodies. This allows for a uniform distribution of stress, avoiding structural damage caused by localized stress concentration, thereby improving the overall stability of the screen bracket 43. Furthermore, the first frame body 46 and the second frame body 47 may be mounted separately and then connected via the securing member 48. This effectively reduces assembly difficulty and improve assembly efficiency. When maintenance or replacement of a component or part is required, the securing member 48 may be disassembled to separate the first frame body 46 and the second frame body 47, thereby facilitating the repair or replacement of the component or part. Moreover, the first frame body 46 and the second frame body 47 may be manufactured separately, which reduces the manufacturing complexity of the screen bracket 43. It is also possible to configure the first frame body 46 and the second frame body 47 to be made of different materials according to actual needs, thereby effectively reducing production costs.

Exemplarily, referring to FIG. 8, an axis of the output member 21 is intersected with a perpendicular bisector of a first isosceles triangle 200. A plane in which the first isosceles triangle 200 lies is perpendicular to the first direction. That is, the axis of the output member 21 is perpendicular to the perpendicular bisector of the first isosceles triangle 200. The guide shafts 31 include two first guide shafts 31a and one second guide shaft 31b. An axis of one of the first guide shafts 31a passes through one of base angle vertices of the first isosceles triangle 200, an axis of the other first guide shaft 31a passes through the other of the base angle vertices of the first isosceles triangle 200, and an axis of the second guide shaft 31b passes through an apex vertex of the first isosceles triangle 200. Correspondingly, two first guide holes 44a are defined in the first frame body 46, and one second guide hole 44b is defined in the second frame body 47.

In the embodiments, by having the two first guide shafts 31a pass through the two base angle vertices of the isosceles triangle, respectively, and the second guide shaft 31b pass through the apex vertex, a stable triangular support structure is formed. This further improves the structural stability of the display screen assembly 4, thereby more effectively preventing the display screen 41 from skewing. The intersection of the axis of the output member 21 with the perpendicular bisector enables the output member 21 to withstand a greater load when driving the display screen assembly 4 to move. This ensures that the display screen assembly 4 remains balanced throughout the movement, thereby preventing wobbling or skewing.

In some examples, having the axis of the output member 21 pass through the geometric center of the first isosceles triangle 200 may further ensure the stability and precision of the movement of the display screen assembly 4.

It should be noted that, in other embodiments, the display screen may have an integral structure, which may be configured according to actual conditions and is not described in detail herein. In other embodiments, the guide assembly may further include more than three guide shafts, which may be configured according to actual conditions and are not described in detail herein.

In some embodiments, referring to FIGS. 4, 7 to 8, and 10 to 11, the display screen assembly 4 may include two securing members 48. The two securing members 48 are symmetrically disposed on two ends of the second frame body 47 in a fourth direction, the fourth direction being perpendicular to both the first direction and the second direction.

In the embodiments, by configuring the two securing members 48, not only is the structure simple, but also the screen bracket 43 is allowed to experience a uniform force distribution, which reduces structural deformation and effectively improves the overall stability of the screen bracket 43.

In some embodiments, referring to FIGS. 8 and 10, each of the securing members 48 includes a threaded portion 481 and a spring portion 482. One end of the threaded portion 481 in the second direction passes through the second frame body 47 along the second direction and is then threadedly connected to the first frame body 46. The spring portion 482 is sleeved onto an outer periphery of the threaded portion 481, and the spring portion 482 is compressed between the threaded portion 481 and the second frame body 47 along the second direction, such that a surface of the first guide shaft 31a is brought into contact with a hole wall of the first guide hole 44a, and a surface of the second guide shaft 31b is brought into contact with a hole wall of the second guide hole 44b.

In the embodiments, the spring portion 482 is sleeved onto the outer periphery of the threaded portion 481 and is compressed between the threaded portion 481 and the second frame body 47. An elastic force of the spring portion 482 acts on the second frame body 47, thereby forming a preload force along the second direction. The preload force is transmitted via the second frame body 47 to the first frame body 46, thereby causing the first frame body 46 to be in close contact with the second frame body 47. In the meantime, the preload force is also transmitted via the guide holes 44 to the guide shafts 31, thereby ensuring that the surfaces of the guide shafts 31 are in close contact with the hole walls of the guide holes 44. This improves the movement precision and stability of the display screen assembly 4, thereby preventing the display screen assembly 4 from skewing and ensuring the imaging performance at different diopters.

In some embodiments, referring to FIGS. 8 and 10, the threaded portion 481 includes a screw 483 and a nut 484, with the nut 484 disposed at one end of the screw 483 in the second direction. A first counterbore 471 and a clearance hole 472 that are sequentially arranged along the second direction and in communication with each other are defined in the second frame body 47. The clearance hole 472 is sized to allow the screw 483 to pass through. That is, a diameter of the clearance hole 472 is equal to an outer diameter of the screw 483, and a diameter of the first counterbore 471 is greater than the outer diameter of the screw 483. A threaded hole 461 arranged corresponding to the clearance hole 472 is defined in the first frame body 46. An end of the screw 483 distal from the nut 484 sequentially passes through the first counterbore 471 and the clearance hole 472 and is then screwed into the threaded hole 461. The spring portion 482 is accommodated within the first counterbore 471. One end of the spring portion 482 in the second direction is abutted against a bottom surface of the first counterbore 471, and the other end of the spring portion 482 in the second direction is abutted against a side surface of the nut 484 that faces the first counterbore 471.

Exemplarily, referring to FIGS. 8 and 10, a second counterbore 473 is defined in the second frame body 47, with the second counterbore 473 disposed at an end of the clearance hole 472 away from the first counterbore 471. A boss 462 configured to be inserted into and mate with the second counterbore 473 is formed on the first frame body 46.

In the embodiments, by configuring the boss 462 and the second counterbore 473, a precise mating fit is achieved when the first frame body 46 and the second frame body 47 are joined. This not only facilitates assembly and improves assembly accuracy, but also effectively increases the contact area between the two frame bodies, thereby improving the overall structural stability of the screen bracket 43, and also reducing structural loosening or damage caused by external impact or vibration.

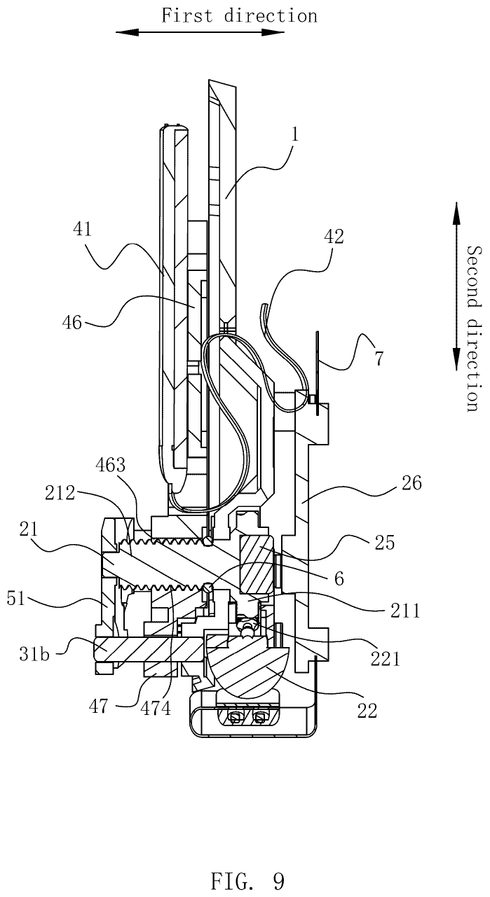

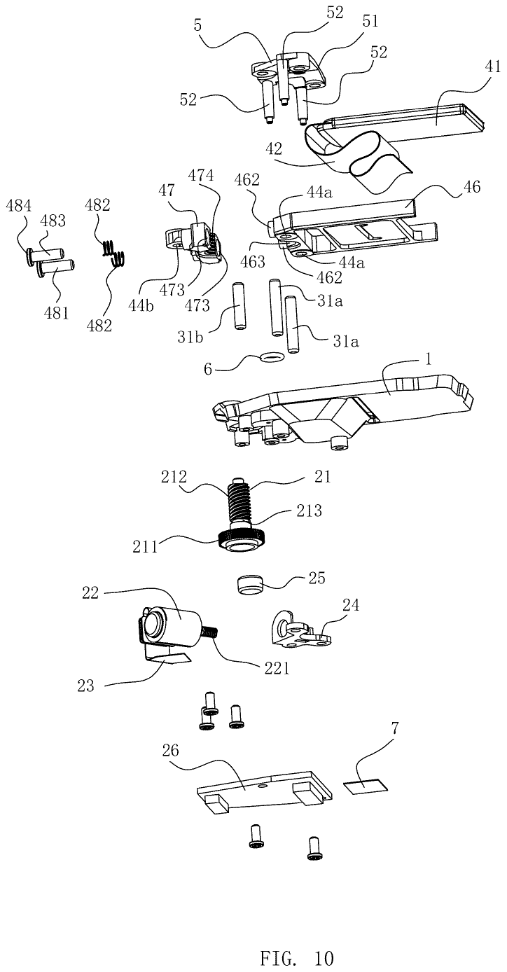

In some embodiments, referring to FIGS. 9 to 11, the first frame body 46 has a first semi-cylindrical surface 463 on a side facing the second frame body 47 in the second direction, and the second frame body 47 has a second semi-cylindrical surface 474 on a side facing the first frame body 46 in the second direction. A female threaded structure configured to engage with the output member 21 is disposed on the second semi-cylindrical surface 474. When the first frame body 46 and the second frame body 47 are assembled together, the first semi-cylindrical surface 463 and the second semi-cylindrical surface 474 join to form the assembly hole 45.

In the embodiments, by configuring the female threaded structure only on the second semi-cylindrical surface 474 while designing the first semi-cylindrical surface 463 as a smooth surface, not only is the potential problem of misalignment errors that may occur when both semi-cylindrical surfaces are threaded effectively avoided, but also rational stress distribution is achieved by concentrating the female threaded structure on the second frame body 47. This significantly reduces the stress on the first frame body 46, which is configured to secure the display screen 41, thereby improving the stability of the display screen 41. Moreover, the female threaded structure of the second semi-cylindrical surface 474 serves as an engagement surface that bears the transmission load, while the smooth surface of the first semi-cylindrical surface 463 serves as a mating surface that only provides radial support. This separation of the transmission function from the support function facilitates precise compensation for the preload force of the spring.

In some embodiments, referring to FIGS. 9 and 10, the display screen assembly 4 further includes a first circuit board 42, and the first circuit board 42 is an FPC. One end of the first circuit board 42 is connected to the display screen 41, and the other end of the first circuit board 42 is connected to a control board of the diopter adjustment device 100. Although the first circuit board 42, in a bent state, generates a restoring force, the preload force generated by the compressed spring portion 482 in the embodiments effectively counteracts the impact of the restoration force generated by the bending of the first circuit board 42. This ensures that the guide shaft 31 maintains stable contact with the guide hole 44, thereby effectively preventing the screen bracket 43 from skewing, and avoiding skewing of the display screen 41. The embodiments not only resolve the problem of skewing of the display screen 41 caused by the deformation of the flexible printed circuit board, but also improve the reliability and service life of the display screen assembly 4.

In some embodiments, referring to FIGS. 2 to 10, the drive assembly 2 further includes a motor 22. The motor 22 is secured to the cover plate 1, and an output shaft of the motor 22 is a worm 221. The worm 221 extends along a third direction, the third direction being perpendicular to the first direction. The output member 21 includes a worm gear portion 211 and a lead screw portion 212 that are coaxially arranged and integrally secured. The lead screw portion 212 is provided at one end of the worm gear portion 211 in the first direction. The worm gear portion 211 is drivingly connected to the worm 221, and the lead screw portion 212 is drivingly connected to the assembly hole 45 of the display screen assembly 4.

In the embodiments, the motor 22 drives the output member 21 to rotate about the axis of the output member 21, which in turn drives the display screen assembly 4 to move along the first direction to adjust the diopter. The electric adjustment provides high precision; a plurality of diopter levels may be predefined, or stepless adjustment of the diopter may be implemented. This satisfies both the need of a single user for repeated adjustments to the same diopter, and the needs of different users for different diopters.

In some embodiments, the worm gear portion 211 is a helical worm gear. It should be noted that, in other embodiments, the worm gear portion may also be other types of worm gears, which may be configured according to actual conditions and is not described in detail herein.

In some embodiments, referring to FIGS. 9 and 10, an annular groove 213 arranged around the axis of the output member 21 is defined in the output member 21, with the annular groove 213 is disposed between the worm gear portion 211 and the lead screw portion 212. The screen movement module 100b further includes an O-ring 6. The O-ring 6 is engaged in the annular groove 213. The cover plate 1 is retained between the worm gear portion 211 and the O-ring 6, thereby constraining the output member 21 on the cover plate 1. The output member 21, constrained on the cover plate 1, is only capable of rotating about its axis relative to the cover plate 1 and fails to move relative to the cover plate 1. This effectively ensures the transmission precision between the output member 21, the worm 221, and the display screen assembly 4. The end of the output member 21 away from the motor 22 in the first direction is rotatably inserted into the plate body 51.

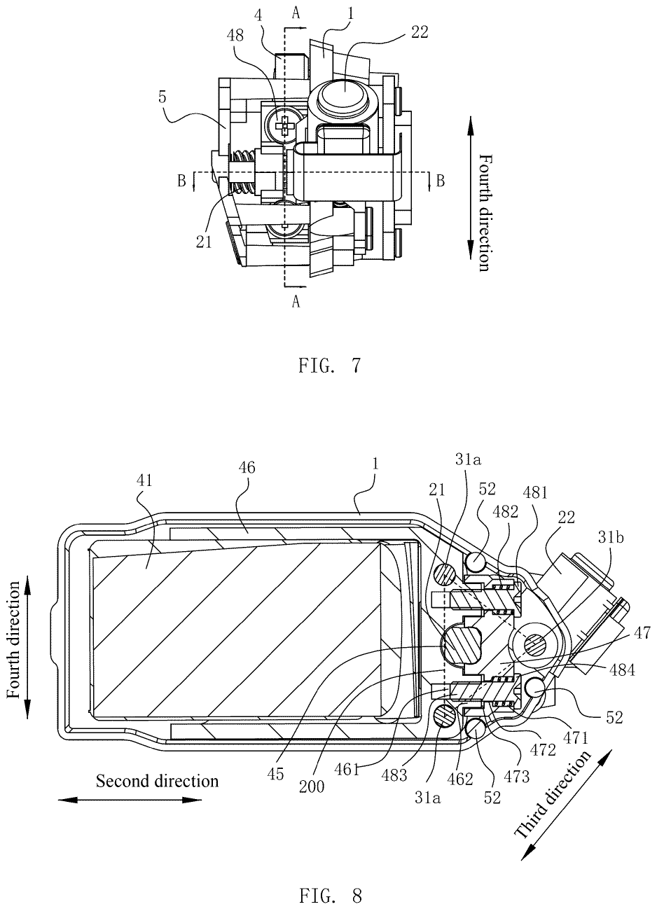

In some embodiments, referring to FIGS. 6 and 10, the drive assembly 2 further includes a motor bracket 24, and the motor 22 is secured to the cover plate 1 via the motor bracket 24.

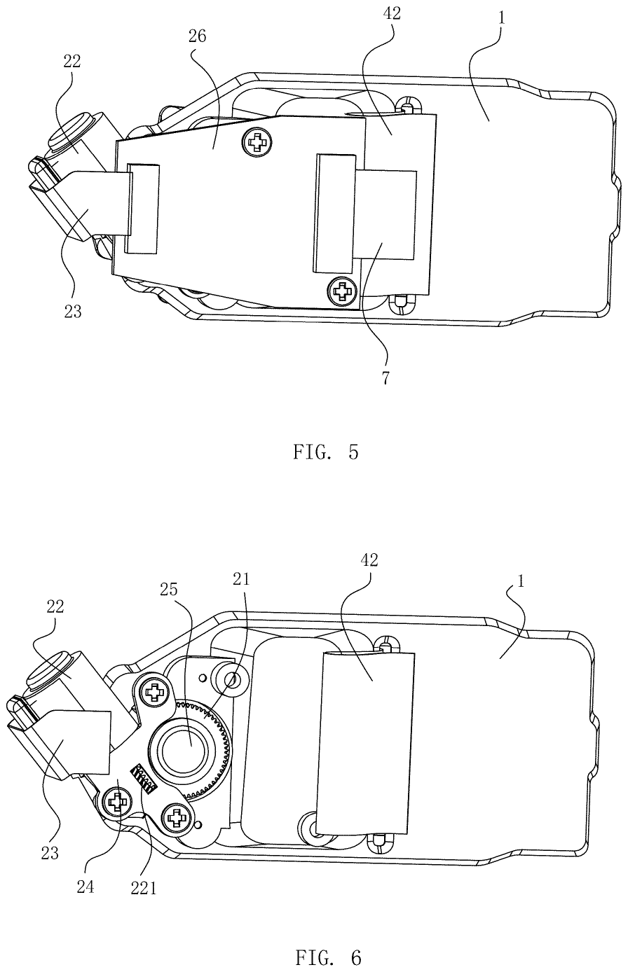

In some embodiments, referring to FIGS. 5, 6, 9, and 10, the drive assembly 2 further includes a magnet 25 and a magnetic sensor 26. The magnet 25 is secured to an end of the output member 21 and is arranged coaxially with the output member 21. The magnetic sensor 26 is secured to the cover plate 1. The magnetic sensor 26 is configured to sense a change in the magnetic field of the magnet 25, thereby detecting a rotation angle of the magnet 25. Since the magnet 25 is arranged coaxially with the output member 21, a rotation angle of the magnet 25 is the rotation angle of the output member 21. That is, precise detection of the rotation angle of the output member 21 may be achieved by means of the magnetic sensor 26, thereby enabling precise control of the screen movement module 100b. Exemplarily, the magnetic sensor 26 is a magnetic encoder board, and the magnetic encoder chip of the magnetic encoder board is arranged corresponding to the magnet 25.

In some embodiments, referring to FIGS. 2, 4 to 6, and 10, the drive assembly 2 further includes a second circuit board 23. Exemplarily, the second circuit board 23 is an FPC. One end of the second circuit board 23 is connected to the motor 22, and the other end of the second circuit board 23 is connected to the magnetic sensor 26.

In some embodiments, referring to FIGS. 2, 5, 9, and 10, the drive assembly 2 further includes a third circuit board 7. Exemplarily, the third circuit board 7 is an FPC. One end of the third circuit board 7 is connected to the magnetic sensor 26, and the other end of the third circuit board 7 is connected to the control board of the diopter adjustment device 100.

In some embodiments, referring to FIGS. 1 and 2, the frame 100a and the cover plate 1 enclose to form an accommodating space. The display screen assembly 4, the guide assembly 3, and the output member 21 are all accommodated within the accommodating space, thereby effectively protecting the display screen assembly 4, the guide assembly 3, and the output member 21, and consequently ensuring the movement precision and stability of the display screen assembly 4.

In some embodiments, the cover plate 1 is secured to the frame 100a by adhesive bonding. Exemplarily, during assembly, the screen movement module 100b is placed into the frame 100a as an integral module. After the display screen 41 is aligned with the lens module, the cover plate 1 is secured to the frame 100a with adhesive, thereby achieving a secure connection between the screen movement module 100b and the frame 100a, and facilitating easy assembly.

It should be noted that, in other embodiments, other structures such as screws may also be used to secure the cover plate and the frame. Such configurations may be made according to actual conditions, which is not described in detail herein.

In some embodiments, referring to FIG. 2, the lens module 100c includes a compensation lens 81, a reflective mirror 82, a first prism 83, and a second prism 84. The compensation lens 81, the reflective mirror 82, the first prism 83, and the second prism 84 are sequentially securely, and the first prism 83 is secured to the frame 100a. In some embodiments, the compensation lens 81, the reflective mirror 82, the first prism 83, and the second prism 84 are secured together with adhesive to form the lens module 100c, and the first prism 83 is then secured to the frame 100a with adhesive.

Exemplarily, the imaging process for a virtual image is as follows: the display screen 41 provides an image, and the image passes sequentially through the first prism 83, the second prism 84, and the reflective mirror 82 before reaching the human eye. A real image passes directly and sequentially through the compensation lens 81, the reflective mirror 82, the first prism 83, and the second prism 84 and before being presented to the human eye. The compensation lens 81 is configured to correct distortion of the real image.

The diopter adjustment device 100 according to the embodiments of the present disclosure may be applied to smart optical devices. Exemplarily, the smart optical device may be AR glasses.

Exemplarily, the smart optical device may include two diopter adjustment devices, with the two diopter adjustment devices include a first diopter adjustment device arranged corresponding to the left eye of a user and a second diopter adjustment device arranged corresponding to the right eye of the user. The diopter adjustment device 100 as illustrated in FIGS. 1 to 11 is the first diopter adjustment device. It is to be understood that the structure of the second diopter adjustment device and the structure of the first diopter adjustment device are symmetrical in the second direction, which is not described in detail herein.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

What is claimed is:

1. A diopter adjustment device, comprising:
a frame, secured to a lens module; and
a screen movement module, including a cover plate, a drive assembly, a guide assembly, and a display screen assembly, wherein the cover plate is secured to the frame, the drive assembly is disposed on the cover plate, the drive assembly is provided with an output member extending along a first direction, the guide assembly comprises at least three guide shafts secured to the cover plate and extending along the first direction, the at least three guide shafts being arranged to surround the output member, and the display screen assembly is drivingly connected to the output member and slidably connected to the guide shafts, such that under driving by the drive assembly, the display screen assembly is capable of moving relative to the lens module along the first direction to adjust a diopter.

2. The diopter adjustment device according to claim 1, wherein the display screen assembly comprises:
a screen bracket, drivingly connected to the output member and slidably connected to the guide shafts, with a retaining slot is defined in one end of the screen bracket in the first direction; and
a display screen, secured to the screen bracket and at least partially received within the retaining slot.

3. The diopter adjustment device according to claim 2, wherein the at least three guide shafts comprise at least two first guide shafts and at least one second guide shaft; and
the screen bracket comprises:
a first frame body, wherein the retaining slot is defined in the first frame body, and at least two first guide holes are defined in the first frame body, the at least two first guide holes being respectively and slidably connected to the at least two first guide shafts;
a second frame body, disposed on a side of the first frame body in a second direction, the second direction being perpendicular to the first direction, wherein at least one second guide hole is defined in the second frame body, the at least one second guide hole being slidably connected to the at least one second guide shaft; and
a securing member, configured to secure the first frame body and the second frame body;
and the first frame body and the second frame body jointly define an assembly hole drivingly connected to the output member.

4. The diopter adjustment device according to claim 3, wherein the securing member comprises:
a threaded portion, passing through the second frame body along the second direction and threadedly connected to the first frame body; and
a spring portion, sleeved on the threaded portion and compressed between the threaded portion and the second frame body along the second direction, such that a surface of each of the at least two first guide shafts is brought into contact with a hole wall of a respective one of the at least two first guide holes, and a surface of the at least one second guide shaft is brought into contact with a hole wall of the at least one second guide hole.

5. The diopter adjustment device according to claim 1, wherein the drive assembly further comprises a motor secured to the cover plate, with an output shaft of the motor is a worm, the worm extending along a third direction perpendicular to the first direction; and
the output member comprises a worm gear portion and a lead screw portion defined at one end of the worm gear portion in the first direction, wherein the worm gear portion is drivingly connected to the worm, and the lead screw portion is drivingly connected to the display screen assembly.

6. The diopter adjustment device according to claim 1, wherein the screen movement module further comprises a magnet and a magnetic sensor; wherein
the magnet is secured to one end of the output member and is arranged coaxially with the output member; and
the magnetic sensor is secured to the cover plate and is configured to detect a rotation angle of the magnet.

7. The diopter adjustment device according to claim 1, wherein the frame and the cover plate enclose to form an accommodating space, wherein the display screen assembly is received within the accommodating space.

8. The diopter adjustment device according to claim 1, wherein the cover plate is secured to the frame by adhesive bonding.

9. The diopter adjustment device according to claim 1, wherein the at least three guide shafts are interference-fitted to the cover plate.

10. The diopter adjustment device according to claim 1, wherein the screen movement module further comprises a limiting frame, the limiting frame comprising a plate body and connecting posts, wherein the plate body is spaced apart from the cover plate in the first direction, one end of each of the connecting posts in the first direction is secured to the plate body, and another end of each of the connecting posts in the first direction is secured to the cover plate; and
one end of each of the at least three guide shafts in the first direction is secured to the cover plate, and another end of each of the at least three guide shafts in the first direction is secured to the plate body.
